(19) United States
(12) Patent Application Publication
(10) Pub. No.: US 2008/0216631 A1
(43) Pub. Date: Sep. 11, 2008

(54) Attachment Apparatus Adapter

(76) Inventors: Jon Ritter, Cazadero, CA (US); Rebecca Ritter, Cazadero, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/996,465

(22) PCT Filed: Jul. 19, 2006
(86) PCT No.: PCT/US06/28568

§ 371 Date: Jan. 22, 2008

Related U.S. Application Data
(60) Provisional application No. 60/700,561, filed on Jul. 19, 2005.

(51) Int. Cl. B27B 19/00

(52) U.S. Cl. 83/699.21; 83/699.31

(57) ABSTRACT

An attachment for a reciprocating tool that enables quicker and simpler exchanging of tool bits. The attachment may have a screw that grips onto, or passes through a hole in, a tool bit, thereby fixedly holding the tool bit to the attachment. Alternatively, the attachment may have a spring-loaded, pivoting arm that grips onto, or passes through a hole in, a tool bit. In such an embodiment, a see-saw shaped lever may be pressed to decompress the spring and thereby release the tool bit. The attachment also is capable of providing a standard tool bit connection, so as to receive and secure ordinary tool bits.

### FIELD OF THE INVENTION

The present invention relates to reciprocating tools. More specifically, the present invention relates to an improved mechanism for attaching pieces to reciprocating tools.

### BACKGROUND OF THE INVENTION

Reciprocating tools are commonly used every day. Quite simply, rather than manually moving a saw or other tool back and forth to perform any other operation, the user chooses to use a reciprocating tool that is powered and can quickly move a blade or other tool back and forth to achieve a result. Various blades and other devices can be purchased and attached to conventional reciprocating tools. For example, a user might choose a first type of blade, plug into a reciprocating tool and cut through a piece of wood. However, if the user wants to cut through dry wall, the user might want a different type of blade that will not splinter the dry wall and will make a clean cut. Thus, the user needs to remove a blade that would be used to cut through wood and replace that blade in the reciprocating tool with a blade that would be conventionally used to cut through dry wall.

The problem occurs when the user wants to quickly and easily remove one blade from the reciprocating tool and place another in the reciprocating tool. Conventional reciprocating tools have an attachment mechanism involving a simple thumb-screw type device. Essentially, a desired blade is slid into an opening on the end of the reciprocating tool and then a thumb screw is tightened down up on the blade. Other reciprocating tools have cylindrical twist mechanisms, wherein the user twists the cylinder to compress a spring. When the spring is compressed, the reciprocating tool can receive an attachment such as a blade. When the user releases the cylindrical piece, the spring decompresses, putting pressure on an inserted blade or other attachment and holding it in the end of the reciprocating tool.

While there are different methods that do hold blades and other attachments into reciprocating tools, there is a need for a device that allows a user to attach a blade or similar tool into a reciprocating tool with a very natural, ergonomic motion.

### SUMMARY OF THE INVENTION

The present invention is a device that allows quick attachment of a tool to a reciprocating tool and also quick detachment of a tool from a reciprocating tool. To use the present invention, a user simply snaps a tool into the reciprocating tool without having to necessarily turn a thumb screw, without having to twist anything. The present invention is designed specifically to allow a tool to be inserted toward a reciprocating tool at an angle, and then shifted into a locking position, so that the tool will not come off of the reciprocating tool during use.

To remove an attached tool from a reciprocating tool, the user simply presses down upon a seesaw mechanism of the present invention. By pressing down on the seesaw mechanism of the present invention, a cylinder is removed from a hole in an attached tool and then the tool can be removed from the reciprocating tool. Pressing down by the user on the seesaw is very simple and fast, takes very little pressure and can be simply done with the user's thumb or finger, thus, obviating the need for extensive twisting, screwing, shifting and tightening the position during the operation of the present invention. When a blade or other tool is inserted into a reciprocating tool, that second end of the seesaw mechanisms provides a fixed point onto which a groove of the blade or other tool is slid on.

### BRIEF DESCRIPTION OF THE DRAWINGS

FIG. 1 shows a side view of a first embodiment of the present invention.

FIG. 2 shows a cross-sectional view of the second embodiment of the present invention.

FIG. 3 shows the end of a tool that would be inserted into the present invention.

FIG. 4 shows an end of a special adapter that would allow conventionally ended tools to be inserted into the present invention.

### DETAILED DESCRIPTION OF THE PRESENT EMBODIMENT

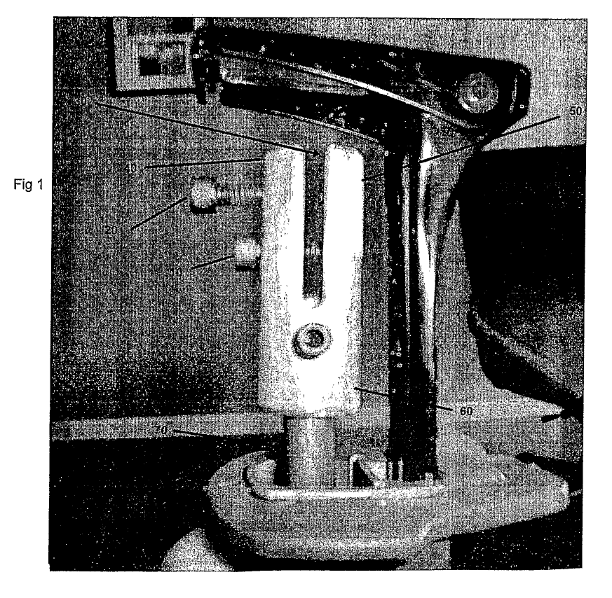

FIG. 1 shows a first embodiment of the present invention art. First member (10) and second member (20) are preferably screws that conventionally penetrate top arm (40). Top arm (40) and bottom arm (50) are separated from one another by channel (30). First member (10) can be seen extending through top arm (40), through channel (30) and into bottom arm (50). Top arm (40) and bottom arm (50) join at base (60) and conventionally mount to a conventional reciprocating tool (70). First member (10) does not move. When the present invention is made, first member (10) is inserted through top arm (40) through channel (30) and into bottom arm (50), and remains fixed, so that it does not leave bottom arm (50).

In use, second member (20) resides partially in top arm (40). The position of second member (20), as shown in FIG. 1, indicates that the present invention, as shown in FIG. 1, is ready to receive a blade or other tool. When a blade or other tool is inserted into the present invention, it is inserted into channel (30). Part of the inserted tool fits onto first member (10). Second member (20) is then screwed down, so that it screws into channel (30) and quite possibly touches bottom arm (50). When second member (20) is screwed down in such a way, it screws through a hole in an inserted tool. Thus, in this way, first member (10) and second member (20) hold an end of an inserted tool via base onto a conventional reciprocating tool (70).

To remove a tool from the present invention, second member (20) is unscrewed, such that second member (20) no longer contacts bottom arm (50), no longer protrudes into channel (30), and thus, the present invention no longer holds a conventional tool.

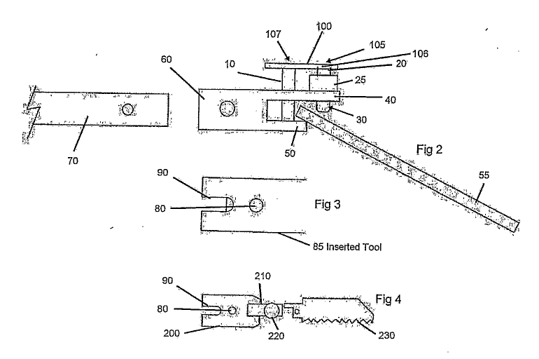

FIG. 2 shows a cross-section view of a second embodiment of the present invention, which is actually the preferred embodiment of the present invention. In FIG. 2, inserted tool (55) fits into channel (30), just like the first embodiment. As shown in FIG. 1, the second embodiment, shown in FIG. 2, has top arm (40) and bottom arm (50). However, in the second embodiment, as shown in FIG. 2, bottom arm (50) has been truncated, so that bottom arm (50) is not as long as top arm (40). The reason for the truncation of bottom arm (50) is so that, as shown in FIG. 2, inserted tool (55) can easily be inserted into the present invention at an angle into channel (30). The user can simply move inserted tool (55) into the same horizontal plane as the present invention is shown in FIG. 2, and inserted tool (55) will be fixedly held in the present invention. Restated, as shown in FIG. 2, inserted tool (55) is placed into the present invention at channel (30) at an approximate 45-degree angle from the horizontal plane of the present invention. Then inserted tool (55) is shifted into the horizontal place to be fixedly held in the present invention. There is a pivoting nexus (106) where second member (20) meets lever (100) that permits inserted tool (55) to move upward into its fixed position.

FIG. 3 is a top view of the inserted end of inserted tool (55). First hole (80) and first screw (90) are positioned at the end of inserted tool (55), such that first hole (80) will line up with second member (20), and first screw (90) will line up with first member (10). When inserted tool (55) is placed in channel (30), first screw (90) is slid onto first member (10), and as inserted tool (55) is shifted from its 45-degree angle relative to the present invention into the same plane as the present invention, first hole (80) will receive second member (20).

To remove inserted tool (55) from the present invention, it is necessary to remove second member (20) from first hole (80), and to remove first member (10) from first groove (90). As shown in FIG. 2, the second embodiment of the present invention has lever (100) that connects the top portions of first member (10) and second member (20). In the second embodiment of the present invention, as shown in FIG. 2, first member (10) and second member (20) do not need to be screws or bolts, but can merely be cylinders, or any other shape that can interact with first hole (80) and first screw (90).

It is also important to note in FIG. 2 that spring (25) is positioned around the upper portion of second member (20) below lever (100) and above top arm (40). Spring (25) is normally in a retracted position at rest. When spring (25) is in a retracted position at rest, second member (20) extends through top arm (40) and through most of, if not all of, channel (30). Thus, when inserted tool (55) is inserted into channel (30), as first screw (90) fits onto first member (10), inserted tool (55) presses against the bottom of second member (20), extending spring (25) as second member (20) is pushed through top arm (40) by inserted tool (55).

Once inserted tool (55) is moved out of its 45-degree angle and into the same horizontal plane as the present invention, first hole (80) aligns with second member (20), and second member (20) presses through first hole (80), and the pressure is released on spring (25), so that spring (25) is contracted and at rest again. Spring (25) essentially is responsible for ensuring that second member (20) normally extends into channel (30), and when inserted tool (55) is inserted into channel (30), that second member (20) will extend through first hole (80).

To remove inserted tool (55) from the present invention, the user must press on lever (100) to affect spring (25), which in turn will affect second member (20) and remove second member (20) from first hole (80). For example, if inserted tool (55) is being held in the present invention, the user would press on lever (100) at second end (107). When the user presses on second end (107), first end (105) of lever (100) will rise, as second end (107) angles slightly. When first end (105) rises, second member (20), which is fixedly attached to first end (105), lever (100) will rise as well and be pulled out of first hole (80). Once second member (20) has been pulled out of first hole (80), first groove (90) can simply be slid off of first member (10), so that inserted tool (55) can be removed.

When the user releases pressure on second end (107) of lever (100), spring (25) will pull first end (105) of lever (100) down, so that second member (20) will again extend into channel (30) and be ready to receive inserted tool (55) on another occasion.

FIG. 4 shows an attachment for a conventional tool in the case where a conventional tool does not have an end that is adapted to fit the present invention. As shown in FIG. 4, an adapter (200) has first groove (90) and first hole (80), just as in FIG. 3. The other side of adapter (200) has a conventional strip of material (210) with a conventional thumb screw (220) to receive a conventional tool (230). Conventional thumb screw (220) fits into conventional tool (230) to hold conventional tool (230) onto adapter (200).

It is important to recognize that the present invention in any embodiment has two points that are used to hold inserted tool (55). One of those points is first member (10) and the second point is second member (20). Because there are two points, first member (10) and second member (20) holding inserted tool (55), inserted tool (55) can be thicker and heavier and stronger than a conventionally inserted tool. First member (10) and second member (20) provide two points in the present invention that inserted tool (55) is fixed to.

I claim:

1. A reciprocating tool attachment system, comprising:
a unit having a first end configured to connect to a reciprocating tool;
a slot in said unit configured to receive a tool bit;
a stationary first member perpendicularly extending into said slot; and
a moveable second member perpendicularly extending into said slot.

2. The system of claim 1, wherein said first member is fixedly positioned in said slot.

3. The system of claim 1, wherein said second member is positioned further from said first end than said first member.

4. The system of claim 1, wherein said second member has a vertically adjustable screw that extends into said slot and either fixedly presses against said tool bit or passes through a hole in said tool bit.

5. The system of claim 1, further comprising said second member configured to be withdrawn from said slot.

6. The system of claim 5, further comprising a pivoting lever that attaches to said first member and said second member.

7. The system of claim 6, wherein said pivoting lever retracts said second member from said slot.

8. The system of claim 6, wherein said second member has a spring and an arm passing therethrough.

9. The system of claim 8, wherein said arm is configured to extend into said slot when said spring is in a relaxed position.

10. The system of claim 9, wherein said slot is configured to receive said tool bit when said spring is in its relaxed position.

11. The system of claim 10, wherein said tool bit is configured to compress said spring when said tool bit is inserted into said slot.

12. The system of claim 11, wherein said first member is configured to receive slot in said tool bit, and said second member is configured to pass through a hole in said tool bit.

13. The system of claim 12, wherein said pivoting lever is configured to decompress said spring when it is pressed down.

14. The system of claim 1, further comprising an adapter configured to attach to said unit and configured to secure to an ordinary reciprocating tool attachment.

15. The system of claim 14, wherein said adapter is configured to secure an ordinary reciprocating tool attachment by means of a thumbscrew.

16. An attachment system for a reciprocating tool, comprising:
a first end securable to a reciprocating tool;
a bottom extension and a top extension configured in parallel with each other and separated by a channel;
said channel configured to receive a tool bit; and
a stationary first member and a moveable second member, said first member and said second member perpendicular with said extensions, and configured to extend into said channel.

17. The system of claim 16, wherein said second member is configured to fixedly secure said tool bit in said channel.

18. The system of claim 16, wherein said second member has a spring-loaded arm configured to extend said second member out from said channel when said spring-loaded arm is in its compressed position.

19. The system of claim 18, wherein said spring-loaded arm is configured to extend out from said channel, and grip said tool bit.

20. The system of claim 16, further comprising an adapter configured to attach to said member and configured to secure an ordinary reciprocating tool attachment by means of a thumbscrew.
